(19) United States
(12) Patent Application Publication
(10) Pub. No.: US 2007/0286138 A1
(43) Pub. Date: Dec. 13, 2007

(54) METHOD AND SYSTEM FOR PROVIDING IP SERVICES USING CABLE INFRASTRUCTURE

(76) Inventor: IIan Kaftan, Los Altos, CA (US)

Correspondence Address: Ilan Kaftan, Kaftan267 Alicia Way, Los Altos, CA, 94022, US

(21) Appl. No.: 11/672,888

(22) Filed: Feb. 8, 2007

Related U.S. Application Data
(60) Provisional application No. 60/774,613, filed on Feb. 21, 2006.

(51) Int. Cl. H04Q 7/24; H04L 12/66; H04L 9/32

(52) U.S. Cl. 370/338; 370/392; 726/4

(57) ABSTRACT

One embodiment of a Wireless Access Point system for use in a hybrid wireless/cable network, the system capable of authenticating a communication device (mobile and non-mobile) via DOCSIS and/or PCMM-compatible protocol and providing the IP service to the communication device in accordance with a result of the authentication. In addition, the Wireless Access Point system is capable to reserve and, at least partly, commit an assignment of network resources required providing QoS corresponding to the providing IP service. The cable modem is capable of sending the converted MAC address or unique identification via DOCSIS and/PCMM-compatible protocol and facilitating an access to at least one IP service associated with said MAC address or other unique identification. In one embodiment, a method of facilitating an access of a communication device to the IP service, the method comprising authenticating a communication device via DOCSIS and/or PCMM-compatible protocol and providing the IP service in accordance with a result of authentication. In another embodiment one or more cable modems within the Wireless Access Point system capable of receiving a wireless MAC address or other unique identification of at least one communication device and authorizing the service on behalf of the communication device.

### CROSS-REFERENCE TO RELATED APPLICATIONS

This application claims the benefit of provisional patent application Ser. No. 60/774,613, filed 2006 Feb. 21 by the present inventor.

### FEDERALLY SPONSORED RESEARCH

Not Applicable

### SEQUENCE LISTING OR PROGRAM

Not Applicable

### BACKGROUND—FIELD OF INVENTION

The present invention relates to methods and systems for providing IP services for mobile and/or nomadic communication devices via hybrid cable/wireless network infrastructure, and in particular, for providing IP services requiring quality of service.

### BACKGROUND—PRIOR ART

Data-Over-Cable Service Interface Specifications (“DOCSIS”) has been established by cable television network operators to facilitate transporting data traffic, primarily internet traffic, over cable and hybrid networks. Recent years have brought a growing demand for service providers to roll out other IP services as, e.g. voice, video-on demand, video conferencing and other multimedia services. Adding more attractive services has become an essential part of the wining strategy for cable operators, as they are called today Multiple Service Operators (MSOs), who want to stay ahead of the competition. Many of these IP services are requiring quality of service (QoS ) or class of service (CoS) treatment.

The problem of creating infrastructure compatible DOCSIS standard and enabling dynamic delivery of multimedia service with controlled service level was recognized in the Prior Art, e.g. in PacketCable multimedia initiative, and various systems were developed to provide a solution, for example:

U.S. Pat. No. 6,944,166 (Chen et al.) entitled “Method for controlling service levels over packet based networks” discloses a method wherein an end user/station can dynamically control the service levels to/from a second user/station (i.e., locally or remotely controlling service levels). The service levels being provided over packet based networks (which may include Internet Protocol (IP) networks). Dynamic control may be provided for either or both of the service level (e.g., priority of transmission, class or type of service, bandwidth, etc.) and allocation of the costs associated with the service levels provided to users of the embodiments. In some embodiments, users, subscribing to a level of service (e.g., a set bandwidth and/or type of service) can request and obtain a different (e.g., better or worse) level of service (e.g., higher bandwidth access, higher priority of transmissions, etc.) for each call or session between the user and a called station over the packet network. Moreover, the level of service provided for the upstream direction (i.e., transmissions from the user) can be different from the level of service provided for the downstream direction (i.e., transmissions to the user). Further, the settlement procedures for the costs of these services can be allocated to the user, to the station called by the user, or a third station.

US Patent application 2003/154,488 (Stein et al.) entitled “Method and apparatus for reserving and releasing bandwidth over a cable network for packet-switched telephony connection” discloses a method for allocating bandwidth over a cable network to establish a packet-switched telephony connection between two endpoints. The method begins by authorizing and reserving an allocation of bandwidth at the time of a call origination sufficient to establish a voice-band data connection between the endpoints. Next, only a portion of the allocation of bandwidth is committed. This committed portion, which is sufficient to establish a compressed voice traffic connection between the endpoints, is a subset of the reserved allocation of bandwidth. The reserved but uncommitted portion of the allocation of bandwidth is released so that it is available for another connection if at least one of the endpoints determines that the connection is to support voice traffic and not voice-band data. This bandwidth portion may be released after a prescribed period of time has elapsed since the establishment of a full send/receive connection without the detection of voice-band data.

US2005/073,997 (Bennet et al.) entitled “PCMM application manager” discloses a method of assigning network resources between network endpoints including providing a session initiation request to an application manager. The application manager is logically and physically decoupled from an application server associated with the network endpoints. This request initiates communication between the network endpoints through the set of network resources. The communication employs an application residing on an application server. The method also includes providing a PCMM message from the application manager to a policy server as a result of the session initiation request. The PCMM message includes at least some information, for example QoS information, embedded in the session initiation request. The method further includes selecting, via the policy server, a set of network resources for creating a path connecting the network endpoints. The policy server selects the set of network assets based on the PCMM message, for example to set QoS for the communication between the two endpoints.

US2005/078,609 (Sharma et al.) entitled “Access switch for a cable network having a zero configuration multimedia service subsystem” discloses an access switch including at least one cable modem termination system. The cable modem termination system (CMTS), when coupled to a hybrid-fiber coaxial cable network, is in communication with a media terminal adapter. The CMTS includes a multimedia service subsystem and a data over cable service interface specification (DOCSIS) subsystem having at least one user configurable parameter. The access switch further includes a network interface module, in communication with the CMTS, that, when the network interface module is coupled to a network, communicates DOCSIS flows between the network and the CMTS. The access switch further includes a management module that, when the access switch is coupled to a management application, receives configuration data to configure the DOCSIS subsystem. When the DOCSIS subsystem is configured, the multimedia subsystem automatically provides multimedia service without additional configuration thereof. US patent application 2005/078,688 (Byron et al.) entitled “State machine for providing dynamic quality of service in a cable network” discloses a cable modem termination system including a data over cable service interface specification (DOCSIS) subsystem that manages a flow associated with a gate and a gate manager (GM) that manages a state of the gate. When the flow is admitted by the DOCSIS subsystem, the DOCSIS subsystem signals to the GM to transition the state of the gate to a reserved state. The GM transitions the state of the gate to the reserved state when the DOCSIS subsystem signals to the GM to transition the state of the gate to the reserved state. When the flow is activated by the DOCSIS subsystem, the DOCSIS subsystem signals to the GM to transition the state of the gate to a committed state. The GM transitions the state of the gate to the committed state when the DOCSIS subsystem signals to the GM to transition the state of the gate to the committed state.

US Patent application 2005/078,689 (Byron et al.) entitled “Providing multimedia services over a cable network” discloses an access switch including a cable modem termination system with a gate manager executing thereon and a route server, in communication with the cable modem termination system, that includes a common open policy service client executing on the route server. The switch further includes a network interface module, in communication with the cable modem termination system and the route server, that, when the network interface module is coupled to a network, communicates common open policy service messages between the common open policy service client and a call management server included in the network. When a first common open policy service message that includes a gate command is received by the common open policy service client, the common open policy service client sends a second message derived from the first common open policy service message to the gate manager. The gate manager receives the second message and processes the gate command.

US Patent Application 2005/254,419 (Barker et al.) entitled “Method and system for providing bandwidth request opportunities for high priority service flows” discloses a method and system comprising different polling rates applied to high priority BE service flows depending on whether the service flow contains, or is about to contain, traffic packets. A high priority service flow is identified upon boot-up of a user device, and defaults to a slow polling mode. A trigger causes the service flow to be serviced as a fast polling mode. The fast polling mode lasts for a predetermined period of time. If traffic continues at the end of the predetermined period of time, the predetermined period of time is reset so that the fast-polling mode continues until traffic flow on the high priority service flow ceases.

International Application WO05/072,321 (Kalyanasundaram et al.) entitled “Policy-based admission control and bandwidth reservation for future sessions” discloses a method for delivering content over a network, the method involving: receiving a request to establish a session at a future time T1 over the network, the requested session for transferring content between a content server and a subscriber's equipment; reserving network capacity necessary to support the requested future session; acknowledging to the requestor that network resources have been reserved for said requester for time T1; and when current time reaches time T1, causing the requested session to be set up for transferring content between the content server and the subscriber's equipment.

### SUMMARY

There is a need in the art to provide for a new system and method enabling delivery of IP services with guaranteed CoS and/or QoS via hybrid wireless/cable infrastructure for nomadic and/or mobile users. The invention, in some of its aspects, is aimed to provide a novel solution capable of eliminating unauthorized access to application servers and/or unauthorized service condition (e.g. unlimited bandwidth on a best-effort basis) provided to nomadic and/or mobile users.

In accordance with certain aspects of the present invention, there is provided a Wireless Access Point system, method of operation thereof in a hybrid wireless/cable network providing at least one IP service, and an IP service provided in accordance with the present invention. The Wireless Access point is capable of authenticating a communication device via DOCSIS and/or PCMM-compatible protocol and providing the IP service to the communication device in accordance with a result of the authentication.

In accordance with further aspects of the present invention, the Wireless Access Point system is further capable to reserve and, at least partly, commit an assignment of network resources required to provide QoS corresponding to the providing service.

In accordance with further aspects of the present invention, the Wireless Access Point system may comprise one or more cable modems capable of receiving a wireless MAC address or other unique identification of at least one communication device and of authorizing the service on behalf of the communication device. This cable modem may be capable of sending the converted MAC address or unique identification via DOCSIS and/PCMM-compatible protocol and facilitating an access to at least one IP service associated with said MAC address or other unique identification.

### DRAWINGS—FIGURES

In order to understand the invention and to see how it may be carried out in practice, a preferred embodiment will now be described, by way of non-limiting example only, with reference to the accompanying drawings, in which:

FIG. 1 is a schematic block diagram of typical hybrid cable/wireless network architecture as is known in the art and typical service flow thereof.

FIG. 2 is a schematic block diagram of hybrid cable/wireless network architecture and typical service flow thereof in accordance with certain embodiments of the present invention.

FIG. 3 is a generalized block diagram of the wireless access point functional architecture in accordance with certain embodiments of the present invention.

FIG. 4 is a generalized service flow of authentication and authorization process in accordance with certain embodiments of the present invention.

FIG. 5 is a generalized service flow of QoS adaptation process in accordance with certain embodiments of the present invention.

FIG. 6 is a generalized registration framework for a mobile device in accordance with certain embodiments of the present invention.

FIG. 7 is a generalized authorization framework during the registration of a mobile device in accordance with certain embodiments of the present invention.

### DETAILED DESCRIPTION PREFERED EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. In the drawings and description, identical reference numerals indicate those components that are common to different embodiments or configurations.

Embodiments of the present invention may use terms such as, processor, computer, apparatus, system, sub-system, module, unit, device (in single or plural form) for performing the operations herein. This may be specially constructed for the desired purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, Disk-on-Key, smart cards (e.g. SIM, chip cards, etc.), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions capable of being conveyed via a computer system bus.

The processes/devices presented herein are not inherently related to any particular electronic component or other apparatus, unless specifically stated otherwise. Various general-purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The term “communication device” used in this patent specification should be expansively construed to cover any kind of CPE (customer premises equipment) device with communication capabilities, including those adapted for coupling with voice, data, video and/or multimedia services. The “communication devices” include fixed (e.g. DECT) and cellular phones, personal and other computers, pagers, radio telephones, dedicated data units (e.g. PDA), TV set-up boxes, digital media centers, wireless information devices (e.g. car control computers, remote security units, industrial processes control units, remote monitoring units, etc.), wireless adapter devices, play stations, etc. etc. The communication device may communicate with another communication device or with other devices (e.g. servers, public switches, service platforms, etc.) via any of possible networks such as, e.g. fixed line network, cellular networks, broadband networks, data communication networks, Internet network, cable networks, etc. and combinations thereof.

The term “IP services” used in this patent specification should be expansively construed to cover any kind of communication services (e.g. data, video, voice, messaging, multi-media applications, etc.) delivering in association with IP packets.

The term “mobile device” used in this patent specification should be expansively construed to cover any kind of communication device used by a mobile and/or nomadic user.

The references cited in the background teach many principles of communication services in a hybrid cable/wireless infrastructure that are applicable to the present invention. Therefore the full contents of these publications are incorporated by reference herein where appropriate for appropriate teachings of additional or alternative details, features and/or technical background.

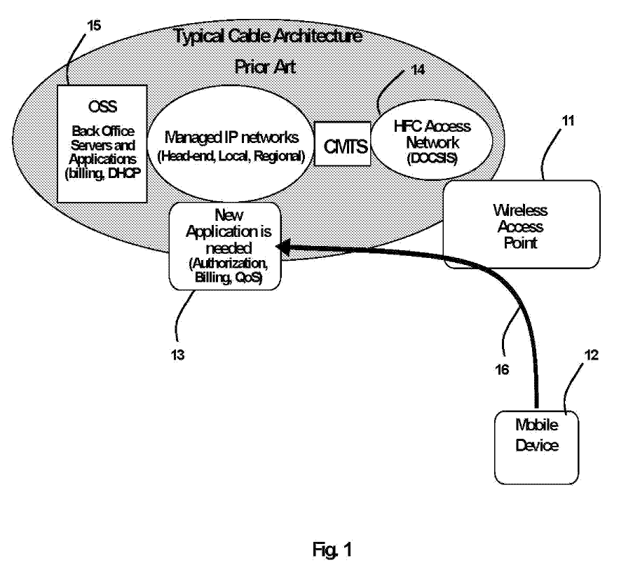

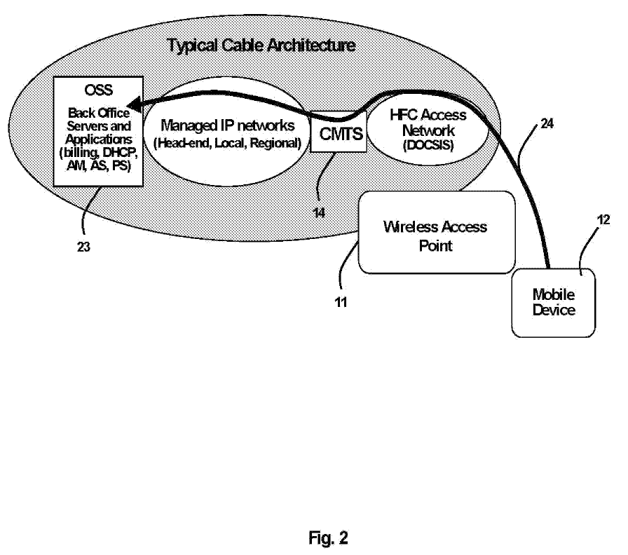

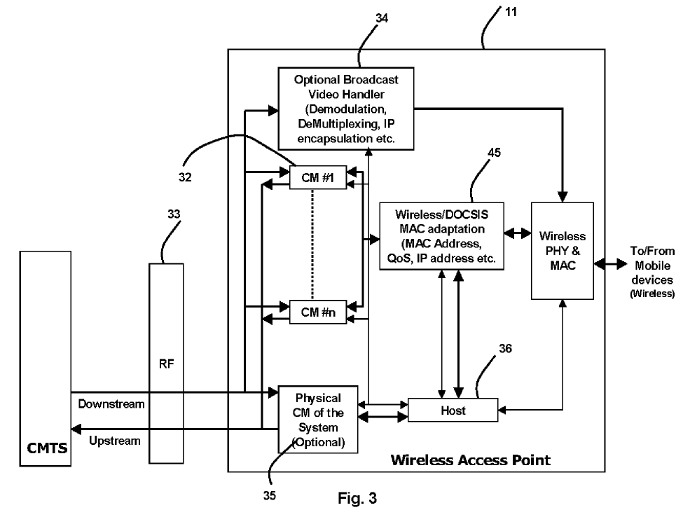

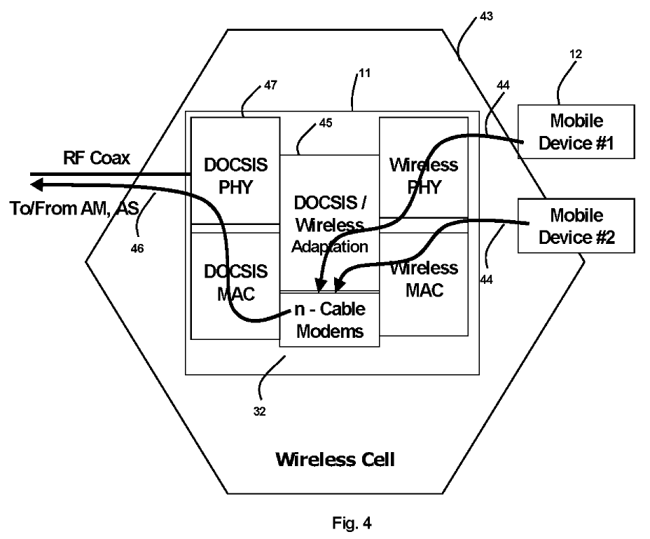

Bearing this in mind, attention is drawn to FIG. 1 illustrating a generalized block diagram of typical hybrid cable/wireless network architecture as is known in the art and typical service flow thereof The illustrated infrastructure comprises Wireless Access Point 11 giving cable operators the ability to offer Hotspot and High-Speed IP services. A request for service received from a communication device of nomadic and/or mobile user 12 (further referring herein as “mobile device”) is forwarding to an application provider 13, while the communication device is anonymous for the DOCSIS 14 and OSS 15. Thus, the user may get an access to application server 13 via 16 before he is authorized. The QoS of connection is non-controlled and, e.g. bandwidth occupied by this un-authorized user may be limited only on best-effort basis. Referring to FIG. 2, there is schematically illustrated a generalized block diagram of hybrid cable/wireless network architecture and service flow thereof in accordance with certain embodiments of the present invention. As will be further detailed with reference to FIGS. 3 and 4, the Wireless Access Point 11 is modified in order to authenticate and authorize the user, and facilitate receiving data necessary for billing records. In accordance with certain embodiments of the present invention, the Wireless Access Point 11 is able to authenticate the user without the installation of any special software other than a standard browser with Secure Sockets Layer (SSL) support. The wireless access point 11 may support different authorization approaches, e.g. send to the OSS 23 an authorization request comprising automatic MAC/Cookie-address logon or basing on 802.11x, receive login information and mediate it to OSS, etc. Accordingly, the Wireless Access Point provides proxied access to OSS (one or more Application Managers and/or Application Servers) using the DOCSIS 24 compatible protocols. OSS 23 will get service request only for mobile users authorized via the Wireless Access Point. The service flow following the authorization may be compatible with DOCSIS standard and Packet Cable Multi Media (PCMM) protocols.

In accordance with further aspects of the present invention, for the authorized user the Wireless Access Point 11 may request for assigning network resources in accordance with a default level of service (e.g. minimal bandwidth with best efforts) until the OSS will facilitate the QoS required in accordance with the user's service request.

In certain embodiments of the invention the authorization information received from OSS 23 may be accompanied with service profile of the user. In other embodiments of the invention the service profile may be pre-loaded, e.g. via residential cable modem. In accordance with further aspects of the present invention the Wireless Access Point may reserve an allocation of network resources at the time of user's authorization in accordance with said service profile, wherein no resources or only part of them may be committed. The committed portion may be provided by default or in accordance with service profile and predefined rules. The reserved but uncommitted portion of the allocation of network resources is released so that it is available for another connection if the corresponding service is not provided or in accordance with an elapsed time.

Once the user leaves the access point coverage area, the corresponding cable modem terminates the service flows of user's device as defined by the DOCSIS standard. If the user returns, the initialization starts again as described above.

Note that the invention is not bound by the specific network architecture described with reference to FIGS. 1 and 2. Those versed in the art will readily appreciate that the invention is, likewise, applicable to any network including cable and wireless parts. The functions of the Wireless Access Point (or part of them) may be implemented in a stand-alone server(s) (as illustrated in FIG. 2), distributed between several platforms or integrated within other network elements. The Wireless Access Point in accordance with present invention may be also located at a moving vehicle, which communicates with the wireless network. Those versed in the art will readily appreciate that the invention is, likewise, applicable to non-mobile communication devices with no assigned cable modems.

Referring to FIG. 3, there is illustrated a generalized block diagram of the Wireless Access Point 11 in accordance with certain embodiments of the present invention. A Wireless Access Point 11 in accordance with current invention may be installed on the network in a manner similar to Wireless Access Points known in the art, for example at the local optical node area. The Wireless Access Point may support any wireless systems, for example such as those based on the standards: 802.11, 802.11e, 802.11g, 802.11n, 802.16, 802.16e or 802.20 as well as 3G. The Wireless Access Point may receive video, data, voice and/or any other IP service from the RF coax or optical lines of the HFC network, and transmit them over the wireless network to the end user such as, for example, a vehicle, laptop or hand held terminal, mobile phone or any other communication device.

The coverage of the Wireless Access Point depends on many parameters such as obstacles in the area, etc., but NLOS (near-line of sight), LOS (line of sight) and/or other known solutions allow to continue reception by the mobile device. An overlap between adjutants Wireless Access Point may enhance the reception and guarantee continuous service while the mobile device is moving from an area covered by one Wireless Access Point to an area covered by a different Wireless Access Point.

The Wireless Access Point is connected to the HFC plant at the RF point 33 (using TAP) or at the optical point, before or after the optical node. We will describe an example in which the box is hooked to the RF 33 cable coming out from the optical node, but it should be appreciated that other configurations are possible and are included in the present invention. Several options are available in order to mount the box: for example, on a strand, on a pedestal, on a wall or on a roof. The antenna can be mounted to the box, to the roof or to the next pole.

Those skilled in the art will readily appreciate that the invention is not bound by the configuration of FIG. 3; equivalent and/or modified functionality may be consolidated or divided in another manner.

In accordance with certain aspects of the present invention, the Wireless Access Point comprises one or more cable modems 32 (CM). Each CM may provide the same functions (or part of them) as a standard cable modem. In addition to these functions, the cable modem is able to facilitate the following process schematically illustrated in FIG. 4:
a) to receive a request 44 for an IP service from one or more mobile devices 12 when the mobile device is establishing a communication with the Wireless Access Point 11 over a wireless protocol 43 (e.g. WiMAX);
b) to recognize a unique MAC address or any other unique identification of the mobile device;
c) to contact the OSS 23 via DOCSIS protocol and to forward the recognized MAC address or other unique identification to the Application Manager (AM) or Application Server (AP) 46 for authentication and authorization of the service and its required Quality Of Service (QoS);
d) once the client or application has been authorized, to facilitate the access to IP service, wherein QoS of the service shall be based on the user profile as shown on the DOCSIS/PCMM system.

The above process is initiated per each service request of a mobile device. In certain embodiments of the invention the CM may be disconnected from the CMTS after above access facilitating process or after the mobile device is no longer under the access point coverage area.

Further in accordance with certain aspects of the present invention, the Wireless Access Point comprises application software capable to facilitate at least the following process schematically illustrated in FIG. 4:
a) to interact the mobile device 12 with the cable network using the Packet Cable Multi Media (PCMM) protocol.
b) to receive the MAC address or any other unique identification from the mobile device 11 , and communicate it directly to either the Application Manager (AP) or the Application Server (AS) 46 as defined by the PCMM protocol in order to authenticate the client (either the mobile device or the application running on the mobile device).
c) to provide sufficient information to convey the QoS needs of the requested service such as video, Voice (VoIP) etc.
d) to use one of the physical cable modems 32 residing in the Wireless Access Point 11 and utilize its IP address so that the Application Manager (AP) or Application Server (AS) will be able to identify the mobile device location (to what Wireless Access Point and CMTS it is connected to).

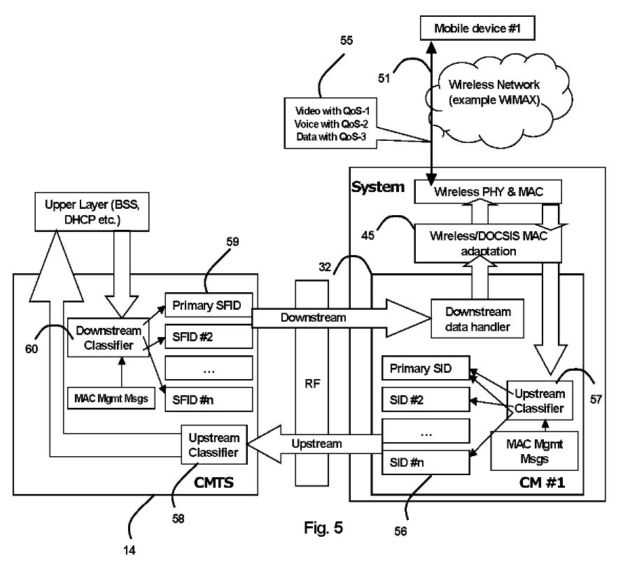

In accordance with certain aspects of the present invention, once the QoS resource is authorized, reserved and committed, based on the DOCSIS 1.1, the CMTS establishes QoS service flow with the cable modem that the mobile device is attached to, once the CMTS is updated by the Policy Server on the policy decisions regarding the mobile device, in accordance with the PCMM standard. The application software is then able to facilitate the following process schematically illustrated in FIG. 4:
a) to adapt the DOCSIS MAC and the wireless MAC 45
b) to map the QoS of the service over the DOCSIS to the wireless network and vice versa.
c) to initiate new service flow for every service received from the mobile device (as illustrated with reference to FIG. 5).

Upon authorization and until the mobile device leaves a coverage area of the Wireless Access Point 11, the mobile device communicates directly with the Application Manager or Application Server via corresponding cable modem 32 in the Wireless Access Point and in accordance with the Packet Cable Multi Media (PCMM) protocol. The IP address of the cable modem is delivered by the DHCP server as defined by the DOCSIS standard 1.0 such that the system identifies the CMTS to which the wireless access point is connected.

Application Server (AS) and/or Application Manager (AM) is also configured to provide functions of MSO back office facilitating sufficient information of a mobile device and services thereof.

Referring to FIG. 5, there is illustrated a generalized service flow of QoS handling in accordance with certain embodiments of the present invention.

The QoS mechanism allows the delivery of different services, downstream and upstream, guaranteeing low jitter and low delay for video and voice services. All QoS modes provide by the DOCSIS will be mapped to the wireless network QoS, guaranteeing the same QoS all the way from the head-end to the end user device. The adaptation 45 will be done on both upstream and downstream channels. The CMTS 14 will grant the cable 32 modem to use an upstream slot for data delivering (video, data or voice) depending on the QoS that a specific service 55 been assigned during the registration process described above, in accordance with the PCMM standard, or later when a session for data transferred is initiated like in the case of VoIP call. Each service been assign by the downstream classifier 60 at the CMTS to service flow ID (SFID) 59, and each service flow has different QoS priority for example, Video: SFID-2 mapped to QoS-1, Voice: SFID-3 mapped to QoS-2, and Data: primary SFID mapped to QoS-3. On the upstream, the upstream classifier assigns each service to a service flow ID 56, which might have different QoS e.g. Video: QoS-1 mapped to SID2, Voice: QoS-2 mapped to SID3, and Data: QoS-3 mapped to primary SID. On the wireless link 51, Video has QoS-1, Voice has QoS-2 and Data QoS-3.

Upon completion of the registration, if the mobile device is allowed to access the network, the connection is done using one of the physical cable modems 32 of the Wireless Access Point. In case the service is not authorized, a service flow for the required service is not created and the device cannot have access to that specific service. If the authentication and authorization pass, the data on the upstream is transmitted from the Wireless Access Point by using the physical cable modem upstream channel for that device.

The downstream channel from the CMTS is shared between all devices and therefore the data is multicast over the wireless network to the devices. On the upstream, each device is granted by the CMTS whenever an upstream data transfer of a specific service, video, data, or voice is needed.

A conversion between the DOCSIS MAC and the 3G or WiFi or WiMAX or 802.20 MAC is also done in the Wireless Access Point and security is enforced on the wireless data using the encryption mechanisms defined by the standards. A DES, Triple DES, DVB common scrambling or other proprietary scrambling methods can also be applied on the downstream data.

The mobile or nomadic device initiates the service whenever a service is needed (in case of a mobile phone whenever it turned on). It initiates the service with all the Wireless Access Points that are within reception range, but transmits the data only to the one with the strongest reception. While the device moves, and the coverage area changes, it initiates connections with other Wireless Access Points and terminates connection with Wireless Access Point that are no longer with reception range.

In the case of mobile phones, when an incoming call is received, the system in the head-end uses a dedicated software to know exactly to which Wireless Access Points the mobile phone is registered, based on the IP address of the physical cable modem allocated for the mobile device, and transmits the signaling and data either to those Wireless Access Points or to the one Wireless Access Point with the best transmission. In any case, the mobile phone replies only to one Wireless Access Point.

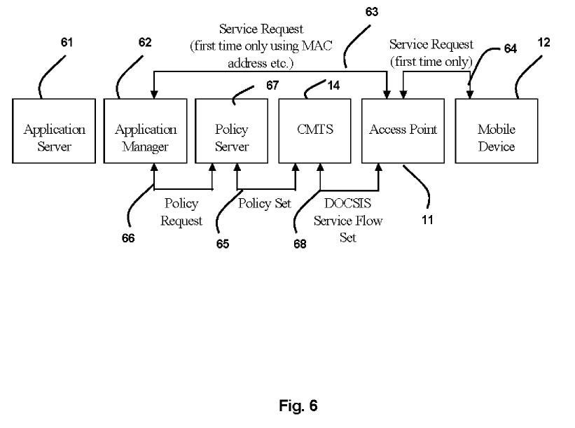

Referring to FIG. 6, there is illustrated registration framework for mobile device in accordance with certain aspects of the present invention.

As was explained with reference to FIGS. 2-5, the Wireless Access point is provided with capabilities to implement sort of proxy that will communicate with the application manager 62 (AM) or application server 61 (AS) on behalf of the mobile device. In order to prevent unauthorized users to access the MSO network (cable HFC), some sort of application need to run inside the access point 11 so it will first check whether the user is allowed to have access, and only than will allow him to have IP address from the DHCP server. This application is a software package running on the host CPU 36 inside the access point. When a mobile device reaches an access point's coverage area, it is authorized and receives an IP address for data access. First, a service flow is created for the device using the cable modem within the access point to the CMTS. The initial service request 64 from the mobile device to the access point, as shown in FIG. 6, is generated once the mobile device has wireless reception from the access point. The access point then uses the MAC address or other unique software key of the mobile device to authenticate the device with the application manager 62, and ask for a primary service flow 63 for that device for basic data access. The application manager uses the policy request 66 as defined by the packetcable multimedia standard, to send a policy request message to the policy server 67, which uses MSO-managed policy rules to allow or discard the request. The policy server sends a policy set message 65 to the CMTS 14, for authorization, reservation and commitment of the QoS resources.

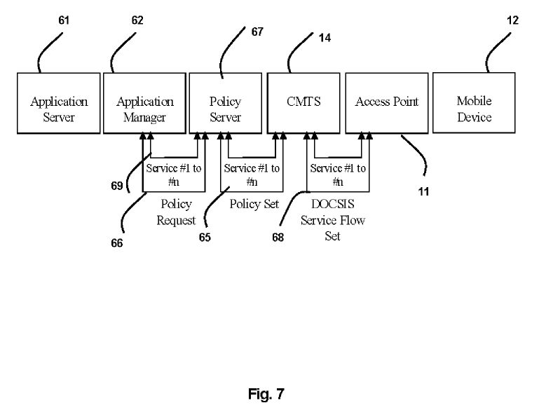

Referring to FIG. 7, there is illustrated authorization framework for a service during registration process of the mobile device in accordance with certain aspects of the present invention.

Included in the spirit of this invention, is the ability of the application manager to authorize several services 69, all at once, based on the subscriber's profile. During the registration process of the mobile device as described above, the application manager can check the subscriber's profile for additional services that need to be authorized as a result of the subscriber pre-subscription (e.g. video streaming, voice etc). The application manager will ask to authorize each service independently 66 as shown in FIG. 7, and a separate service flow may be generated for each service 68. More than one service can use the same service flow if QoS requirements allow it. Using this approach, the mobile device may not need to generate a service request or application request since it already has all the services authorized. The advantage of this approach is that the mobile device does not need to negotiate with the application manager or application server, while all of the benefits of the packet cable multimedia standards are still kept such as event messages to the Record Keeping Server (RKS), QoS etc. The service flow 68 type that is created can be provisioned e only, admitted or active depending on the service itself, e.g. the primary service flow is active for data access while for voice service it may be only provisioned. For those service flow that are only provisioned, the cable modem inside the access point or the CMTS will change the service type to admitted and than active as a result of the service state. For example for voice service, on incoming or outgoing call the state of the service flow is changed. An additional option is that a file is loaded to the access point from the AM or the provisioning server using TFTP the same way cable modem gets its unique file during the initialization process. The structure of the file will be similar to the structure of the service flow structure within the cable modem file, General Packet Classifier Encoding (Service Flow reference, Service Flow Identifier etc). The cable modem that is serving the mobile device to which the file is belonged, will initiate the dynamic service addition according to the service flows defined in the file.

Once the registration process is completed, the mobile device has at least one service flow assigned to him 69. The mobile device itself (defined as client in the packet cable multimedia standard) or an application running on the mobile device, may request an application-specific service by sending a service request either to the application manager or the application server, exactly as defined in the packet cable multimedia standard.

### CONCLUSION, RAMIFICATIONS, AND SCOPE

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the system according to the invention, may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims

1. In a hybrid wireless/cable network providing at least one IP service, a Wireless Access Point system capable of authenticating a communication device via DOCSIS and/or PCMM-compatible protocol and providing the IP service to the communication device in accordance with a result of the authentication.

2. The Wireless Access Point system of claim 1 further capable to reserve and, at least partly, commit an assignment of network resources required providing QoS corresponding to the providing IP service.

3. The Wireless Access Point system of claim 1 or 2 wherein the communication device is a mobile device.

4. The Wireless Access Point system of any one of claims 1 to 3 comprising one or more cable modems capable of receiving a wireless MAC address or other unique identification of at least one communication device and authorizing the service on behalf of the communication device.

5. The Wireless Access Point system of claim 4 wherein the cable modem is capable of sending the converted MAC address or unique identification via DOCSIS and/PCMM-compatible protocol and facilitating an access to at least one IP service associated with said MAC address or other unique identification.

6. In a hybrid wireless/cable network providing at least one IP service, a method of facilitating an access of a communication device to the IP service, the method comprising authenticating a communication device via DOCSIS and/or PCMM-compatible protocol and providing the IP service in accordance with a result of authentication.

7. The method of claim 6 wherein the communication device is a mobile device.

8. The method of claims 6 or 7 wherein the method further comprises reserving and, at least partly, committing an assignment of network resources required to provide QoS corresponding to the providing IP service.

9. The method of any one of claims 6 to 8 further comprising sending the converted MAC address via DOCSIS and/or PCMM-compatible protocol and facilitating an access to at least one IP service associated with said MAC address or other unique identification.

10. In a hybrid wireless/cable network providing at least one IP service, a method of providing IP service for at least one communication device, wherein the access to the IP service is provided in accordance with any one of claims 6-9.
